(19) United States
(12) Patent Application Publication
(10) Pub. No.: US 2021/0157138 A1
(43) Pub. Date: May 27, 2021

(54) STORAGE DEVICE WITH A MESSAGE PROJECTION FUNCTION

(71) Applicant: WALTON ADVANCED ENGINEERING INC., Kaohsiung (TW)

(72) Inventors: Hong Chi YU, Kaohsiung (TW); Mao Ting CHANG, Kaohsiung (TW)

(73) Assignee: WALTON ADVANCED ENGINEERING INC., Kaohsiung (TW)

(21) Appl. No.: 17/079,561

(22) Filed: Oct. 26, 2020

(30) Foreign Application Priority Data
Nov. 22, 2019 (TW) 108142500

(51) Int. Cl. G02B 27/01; B60K 35/00

(52) U.S. Cl. CPC G02B 27/0101; B60K 2370/334; B60K 35/00

(57) ABSTRACT

The present application relates to a storage device with a message projection function such that image light from an image generation unit of an information outlet, which has been electrically connected with an dedicated storage module, passes through and is diffused by a diffusion unit for projection of a created virtual image on a surface.

### BACKGROUND INVENTION

### Field of the Invention

The present application relates to a storage device with a message projection function which relies on a light source to display a message for promotion of technological aesthetics, no large-size display panel occupying more spaces, and minimized safety risks through interactions substituting a current internet authe

### ntication process based on a netwstge device.

### Description of the Prior Art

In the era of internet prevalent, the storage of an individual's information is fulfilled through a public cloud or other alternative storage options including a personal storage device or a self-built private cloud, each of which is reassuring comparaly witerlivacy nto account.

Compared with a public cloud which is infamous for endless data breach, a personal storage device or a self-built private cloud in a private environment is trustworthy comparatively. For no further security issues in a private environment, the display and transmission of a message within ahate ironment deserve to be strengthened.

The patent documentations with respect to displaying a message with respect to a storage device are shown as follows:

The U.S. Pat. No. 13/163,201 discloses a machine-implemented method for authenticating a user session associated with a user, which comprises steps as follows: displaying a personalized digital image on a display screen; receiving a user drawing set superimposed on the personalized digital image and including multiple drawing set members wherein at least two of the multiple drawing set members comprise a user touch point indicating a position associated with the personalized digital image, a user circle gesture indicating a first set of positions associated with the personalized digital image, a user freestyle form gesture indicating a second set of positions associated with the personalized digital image, or a user line gesture indicating a third set of positions associated with the personalized digital image; and authenticating access to the user session if the position, the first set of positions, the second set of positions, or the third set of positions of the at least two of the multiple drawing set members in the user drawing set matches a library drawing set associated with the user.

Taiwan patent 1468977 discloses a storage device authentication system, an authentication method and a network storage device. The authentication system includes a client electronic device, a network storage device with an authentication proxy, and a directory server (DS) with an authentication service module and an account database: the client electronic device chooses a data access service and transmits both encrypted data and user data to the network storage device; the authentication proxy packs the encrypted data and the user data into authentication logon information and transmits the authentication logon information to the DS; the authentication service module receives the authentication logon information and performs decryption and comparison on the authentication logon information according to a corresponding authentication service protocol and corresponding account information in the account database in order to determine a successful authentication and send the authentication to the network storage device.

Taiwan patent 1389006 discloses a method for authentication of an external storage device operatively connected to a port of a host computer wherein the host computer conducts a handshake with the external storage device to seek an authentication key from the external storage device: the host computer electrically disconnects the external storage device from the host computer if the authentication key is incorrect or not provided within a predetermined period; the host computer allows access to the host computer by the external storage device if the authentication key is correct and provided within the predetermined period. Furthermore, an apparatus and a system for authentication of an external storage device are also disclosed in Taiwan patent 1389006.

However, there are still some doubts about packet tampering in graphic authentication and transmission validation as well as ease deciphering of a real password entered at a traditional physical keypad according to positions of pressed keys. Accordingly, the present application offers a storage device with a message projection function to settle the above problems.

### SUMMARY OF THE INVENTION

In virtue of above problems, the present application offers a storage device with a message projection function through which a message is projected optically.

Accordingly, the present application offers a storage device with a message projection function through which image light is projected diffusively by a diffusion unit for a larger display area of a message.

The present application offers a storage device with a message projection function through which image light is projected on any surface effectively for technological aesthetics of a product.

Th_{e p}resent application offers a storage device with a message projection function in which a light-transmitting unit is installed additionally for a further display area of a message.

The present application offers a storage device with a message projection function in which an interaction unit is installed additionally for further interactions through a projected message.

The present application offers a storage device with a message projection function which relies on an interaction unit for further interactions without risks of authentication packets captured and deciphered in a network authentication step during tradition key-in.

The present application offers a storage device with a message projection function in which an upright rack unit is installed additionally for displaying a message on a stable platform.

To this end, a storage device with a message projection function is embodied through the main technical measures as follows. The present application offers a storage device with a message projection function comprising: an information outlet with an image generation unit from which image light is projected; a dedicated storage module with a diffusion unit which receives and intensifies the image light; the storage device with a message projection function is characterized in that the image light passing through the diffusion unit is diffused by the diffusion unit for projection of a created virtual image on a surface when both the dedicated storage module and the information outlet are electrically connected with each other.

A storage device with a message projection function is further embodied by the following technical measures.

In the above storage device, the dedicated storage module comprises a light-transmitting unit on which the image light is projected.

In the above storage device, the dedicated storage module comprises an interaction unit which is electrically connected with a control unit.

In the above storage device, the dedicated storage module comprises an angle adjustment unit with which an angle of projection of light from the diffusion unit is controlled.

In the above storage device, the virtual image includes a message with respect to the dedicated storage module.

In the above storage device, the dedicated storage module comprises an upright rack unit with a surface on which the created virtual image is projected.

In the above storage device, the dedicated storage module comprises a special plug which is electrically connected with the information outlet.

In the above storage device, the dedicated storage module comprises a board, a controller, a storage unit and a housing.

Compared with the prior art, a storage device with a message projection function proves effective in: (1) depending on a diffusion unit to diffusively project image light and a message on a larger display area and overcome the restriction of a traditional large-size display panel occupying more spaces; (2) promoting interactions of a projected message through an interaction unit; (3) replying on an extra light-transmitting unit for a further display area of a message; (4) resorting to interactions with an interaction unit to avoid risks of authentication packets captured and deciphered in a network authentication step during tradition key-in.

### BRIEF DESCRIPTIONS OF THE DRAWINGS

FIG. 1 is a schematic perspective view of a storage device with a message projection function in a preferred embodiment.

FIG. 2a is an exploded perspective view of a storage device with a message projection function in a preferred embodiment.

FIG. 2b is a sectional view of a storage device with a message projection function in a preferred embodiment.

FIG. 2c is a first top view of a storage device with a message projection function in a preferred embodiment.

FIG. 3a is a schematic view of a storage device with a message projection function which is assembled in a preferred embodiment.

FIG. 3b is a first schematic view of a storage device with a message projection function in which all components join together in a preferred embodiment.

FIG. 4a is a second schematic view of a storage device with a message projection function in which some components join together in a preferred embodiment.

FIG. 4b is a schematic view for transmission of image light in a storage device with a message projection function in a preferred embodiment.

FIG. 5a is a first schematic view for projection of a storage device with a message projection function in a preferred embodiment.

FIG. 5b is a second schematic view for projection of a storage device with a message projection function in a preferred embodiment.

FIG. 6 is a third schematic view for projection of a storage device with a message projection function in a preferred embodiment.

### DETAILED DESCRIPTIONS OF THE PREFERRED EMBODIMENTS

A storage device with a message projection function is explained in the preferred embodiments for clear understanding of purposes, characteristics and effects of the present application.

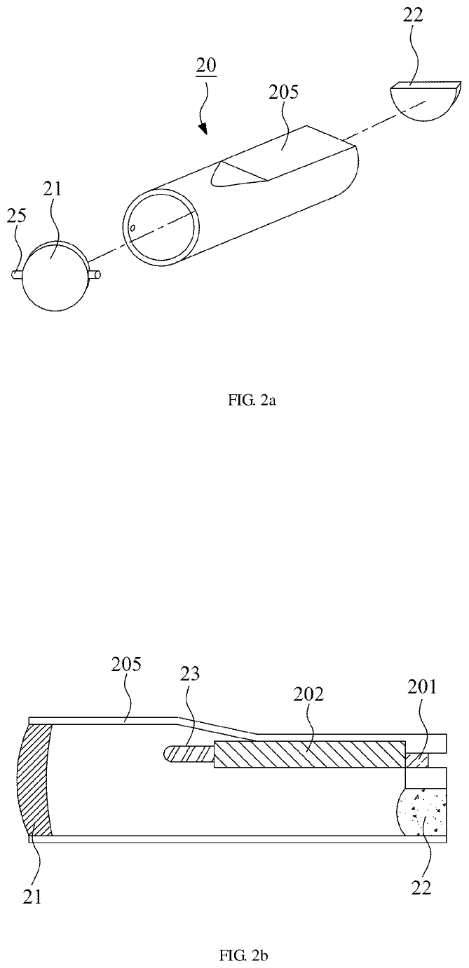

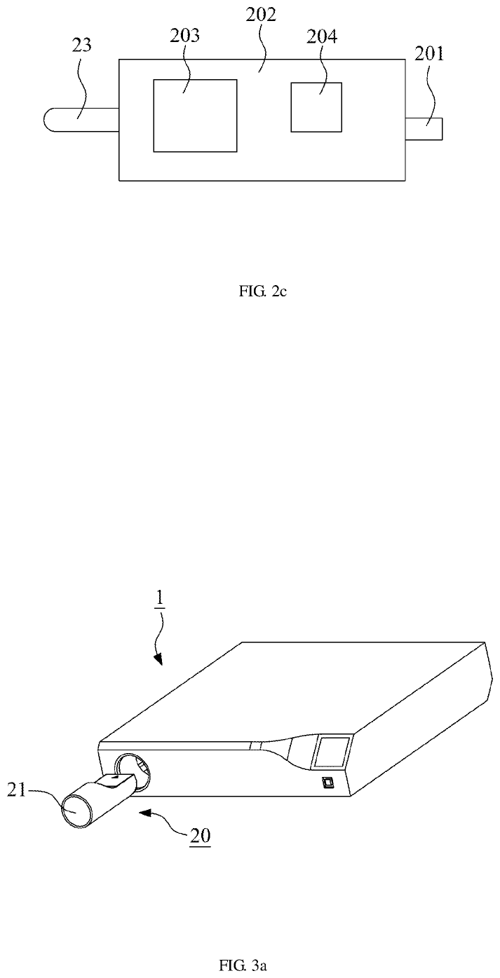

First of all, referring to FIGS. 2b and 3b, which illustrate a storage device with a message projection function in a preferred embodiment is divided into an information outlet (10) and a dedicated storage module (20).

As shown in FIG. 3b, the information outlet (10) that is an external part of a storage device (1) is effective in electric connection with the dedicated storage module (20) for information exchanges and provided with an image generation unit (11) through which information in the storage device (1) is displayed based on optical projection; moreover, referring to FIG. 3a, which illustrates the storage device (1) in FIG. 3b is covered with a housing.

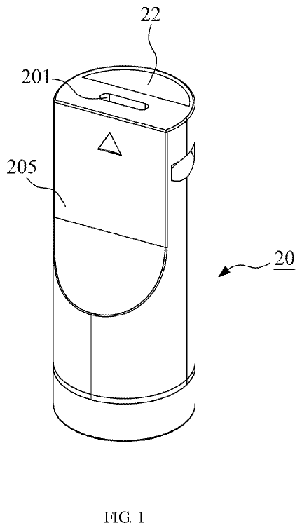

Fᵤᵣthermore, referring to FIGS. 1, 2a, 2b and 2c, which illustrate the dedicated storage module (20) comprises a diffusion unit (21), a special plug (201), a board (202), a controller (203), a storage unit (204) and a housing (205); in the present disclosure, the dedicated storage module (20) is a storage module with a proper storage capacity for secure encryption and magnifies a projection area of an image particularly through the diffusion unit (21) with which light rays directed from one side are diffused for magnifying projection and projected from the other side.

In the present disclosure, the special plug (201) is an electric terminal manufactured as a plug with particularly defined physical specifications (as shown in FIG. 1) rather than universal specifications for no beyond-design electric contact; the board (202) is a circuit board usually, for example, a single-layered or multi-layered printed circuit board, a lead frame, a polyimide, a BT circuit board or a flip chip substrate, and comprises circuits interiorly (not shown in figures) as an interface for electric transmission; the controller (203) is a logic machine with which a complicated computer program is executed; the storage unit (204) means non-volatile memories (NVRAM) in which configurations and/or data are saved but not erased after disconnection of power; the housing (205) is effective in protecting components inside the dedicated storage module (20) and covering most of the components.

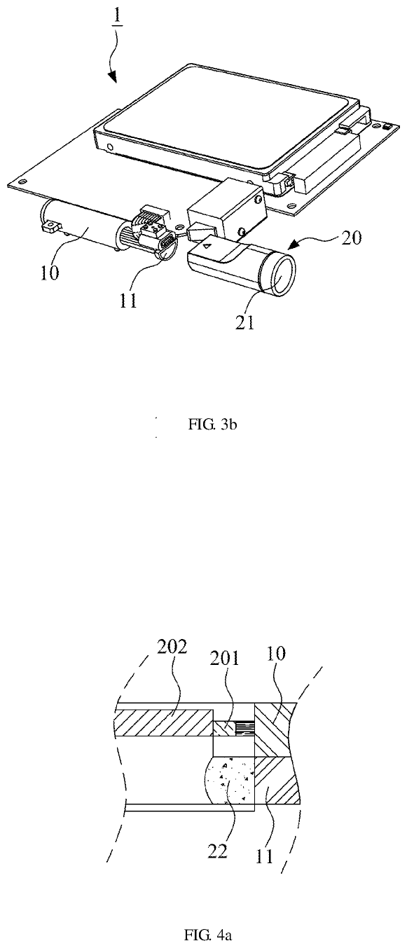

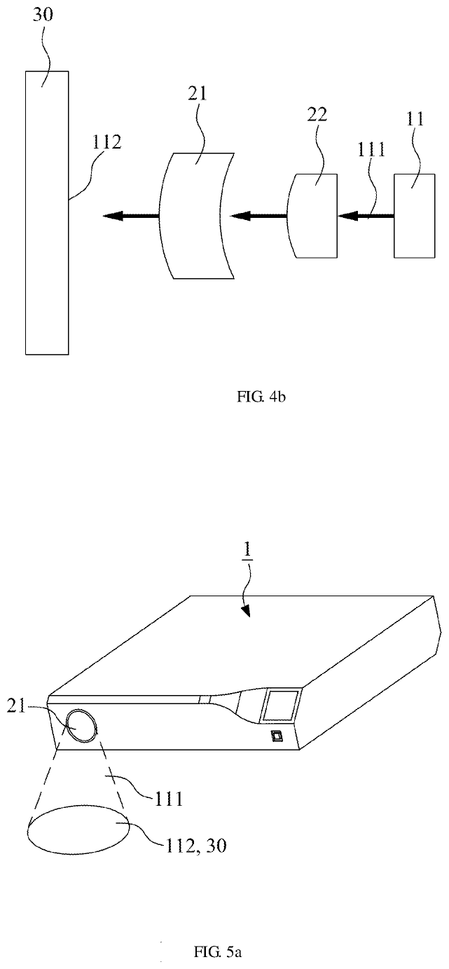

Specifically, the special plug (201) of the dedicated storage module (20) is ready to connect with the information outlet (10), as shown in FIG. 3b; next, as shown in FIG. 4a, the special plug (201) is electrically connected with the information outlet (10); as shown in FIGS. 4a and 4b, the image generation unit (11) of the information outlet (10) projects image light (111) and the image light (111) passes through the diffusion unit (21) with which the image light (111) is diffused for generation of a virtual image (112) to be projected on a surface (30) (as shown in FIG. 5); in the present disclosure, the virtual image (112) includes information with respect to the dedicated storage module (20), for example, available storage capacity, used storage capacity currently, sharing status, etc.

Preferably, the dedicated storage module (20) comprises a light-transmitting unit (22) and an angle adjustment unit (25): the light-transmitting unit (22) on which the image light (111) is projected, as shown in FIG. 4b, is capable of magnifying a projection area of the image light (111) when the image light (111) from the image generation unit (11) is directed to the light-transmitting unit (22) for a larger projection area diffusively and projected on the diffusion unit (21) at the other side for magnifying projection of the virtual image (112) finally; the angle adjustment unit (25) that is a fixed structure around the periphery of the diffusion unit (21), as shown in FIG. 2a, is used to fasten the diffusion unit (21) at the housing (205) such that the diffusion unit (21) is rotatable for a controllable angle of projection and an adjustable projecting position based on a user's requirements or environmental restrictions; the dedicated storage module (20) is supplemented by an upright rack unit (26) that is a fixed angular structure for projecting the virtual image (112) on the surface (30) of the upright rack unit (26).

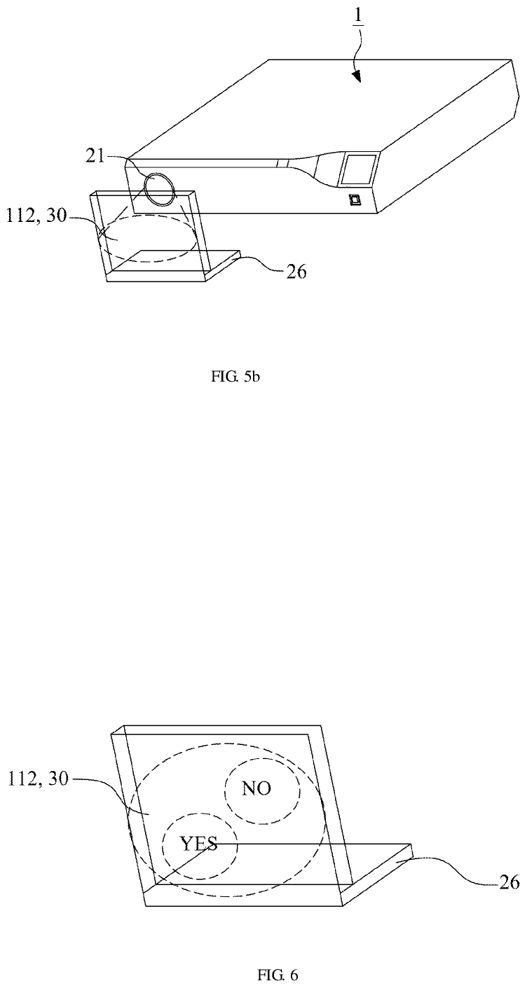

Moreover, as shown in FIG. 2c, the dedicated storage module (20) is provided with an interaction unit (23) which is electrically connected with the control unit (24) through the board (202); in the present disclosure, the interaction unit (23) is used to monitor interactions between a user and the virtual image (112) effectively, for example, a corresponding password is sent for a response to projected password information or a message of “Yes” or “No” is answered for a reply to an inquiry projected (as shown in FIG. 6).

In the above embodiment, the feature of image light diffusively projected on a surface by the diffusion unit (21) for displaying a message on a larger projection area promotes technological aesthetics of a product and interactions through the interaction unit (23) for neither a traditional input step nor an internet authentication process during which packets are captured and decrypted at risk. Accordingly, a storage device with a message projection function which is different from ordinary storage devices and referred to as creative work in applications of a storage device meets patentability and is applied for the patent.

It should be reiterated that the above descriptions present the preferred embodiments of a storage device with a message projection function and any equivalent changes in specifications, claims or drawings still belongs to the technical field within the present disclosure with reference to claims hereinafter.

What is claimed is:

1. A storage device with a message projection function, comprising an information outlet with an image generation unit from which image light is projected and a dedicated storage module with a diffusion unit, which receives and intensifies the image light, and characterized in that the image light passing through the diffusion unit is diffused by the diffusion unit for projection of a created virtual image on a surface when both the dedicated storage module and the information outlet are electrically connected with each other.

2. The storage device as claimed in claim 1 wherein the dedicated storage module comprises a light-transmitting unit on which the image light is projected.

3. The storage device as claimed in claim 1 wherein the dedicated storage module comprises an interaction unit which is electrically connected with a control unit.

4. The storage device as claimed in claim 1 wherein the dedicated storage module comprises an angle adjustment unit with which an angle of projection of light from the diffusion unit is controlled.

5. The storage device as claimed in claim 1 wherein the virtual image includes a message with respect to the dedicated storage module.

6. The storage device as claimed in claim 1 wherein the dedicated storage module comprises an upright rack unit with a surface on which the created virtual image is projected.

7. The storage device as claimed in claim 1 wherein the dedicated storage module comprises a special plug which is electrically connected with the information outlet.

8. The storage device as claimed in claim 1 wherein the dedicated storage module comprises a board, a controller, a storage unit and a housing.
